(19) United States
(12) Patent Application Publication
(10) Pub. No.: US 2002/0066162 A1
(43) Pub. Date: Jun. 6, 2002

(54) Casement window operator having folding crank handle

(76) Inventors: Marlo G. Van Klompenburg, Pella, IA (US); David J. Vande Steeg, Pella, IA (US); Robert S. Evers, Pella, IA (US); Andrew W. Middleswart, Indianola, IA (US); Bruce A. Baier, Pella, IA (US); Gregory J. Vetter, Owatonna, MN (US)

Correspondence Address: HOVEY, WILLIAMS, TIMMONS & COLLINS, Suite 400, 2405 Grand, Kansas City, MI, 64108, US

(21) Appl. No.: 09/730,996

(22) Filed: Dec. 6, 2000

(51) Int. Cl. B62B 7/00

(52) U.S. Cl. 16/429; 49/341

(57) ABSTRACT

The operator assembly for a casement window includes a folding crank handle and cover assembly that are located on the exterior surface of a trim piece on the sill of the window frame. The crank handle is attached to the drive shaft of the operator of the assembly in such a way that the handle may be folded down into a low-profile position in which the knob of the handle projects into a receiving pocket in the cover. An integral flap on the handle extending beyond the knob covers the pocket when the knob is received therein so as to fully conceal both the knob and the pocket and to present a smooth exterior in which surfaces of the handle and cover blend together to eliminate interference with window treatments and persons in the immediately vicinity. Internal detent projections within the pocket yieldably retain the knob so as to provide for snap fit reception of the folded handle into its home position. Finger depressions in sidewalls of the cover on opposite sides of the pocket facilitate gripping of the edges of the handle for unfolding, even though the handle presents a relatively thin cross sectional configuration in the vicinity of the cover flap and pocket. An alternative embodiment discloses an egress operator assembly in which the single link arm that swings the sash between opened and closed positions has a hump adjacent its inner end that clears the worm gear of the operator assembly when the arm is in its fully closed position, thus allowing the arm to cross over the worm gear and lie along the sill in a compacted condition when the sash is closed.

### TECHNICAL FIELD

The present invention relates to the field of fenestration products and, more particularly, to an operator assembly used to swing open and closed the sash of a casement window.

### BACKGROUND

Casement windows employ a sash that swings open and closed about an upright axis along one vertical edge of the sash. Operator assemblies for effecting that swinging motion have been available for many years in various forms. See, for example, U.S. Pat. Nos. 4,392,330 and 5,006,766 owned by the assignee of the present invention. Folding crank handles on such operator assemblies have also been commercially available for some time. However, such prior art arrangements have not been optimal with respect to aesthetics, ease of use, lack of interference with window treatments, reliability and other factors. Accordingly, the present invention is provided to overcome these deficiencies in the prior art and to furnish additional benefits.

### SUMMARY OF THE INVENTION

The present invention provides a casement window operator assembly in which the crank handle can be folded down into a low-profile, unobtrusive storage position in which the gripping knob of the handle is fully concealed and out of the way so as to provide enhanced aesthetic appeal and avoidance of interference with various window treatments and physical contact with persons in the vicinity. The structural features and relationships of the cover and folding crank handle assembly are such that when the crank handle is folded up, it is not immediately apparent to the casual observer that the article being observed, with its graceful lines and unobtrusive appearance, can be quickly and easily transformed into a utilitarian apparatus having the function of opening and closing the sash when manually operated.

The operator of the assembly, including a linkage to the sash, a helical gear and an input worm gear, is located in a recess in the sill of the window. A trim piece on the sill is notched out to expose the operator, but a decorative cover overlies the notch to conceal the operator. Through a hole in one end of the cover, an input drive shaft from the worm gear projects outwardly and upwardly beyond the top wall of the cover where it is operably coupled with the folding crank handle assembly. An adapter or mount of the handle assembly is fixed to the drive shaft and provides a pivotal support for the crank handle itself, which can thereby be swung between a folded down position essentially flush with the cover and a folded out operating position in which the handle projects outwardly from the drive shaft to assume the functional role of an operating crank. The crank handle has a knob projecting outwardly from its underside which is gripped by the user when winding the crank handle around the axis of the drive shaft to swing the sash open and closed. When the crank handle is in its folded position, the knob projects into a receiving pocket in the cover so as to allow the handle to lie substantially flush against the top wall of the cover and completely within its lateral margins. A flap extension of the handle projects beyond the knob and overlies the pocket when the handle is folded down, thus completely concealing the knob and contributing to compactness of the assembly and the smooth, uncluttered and unobtrusive nature thereof.

The handle tapers in thickness as its operating end in the vicinity of the knob is approached so as to compensate for the increased height of the cover in that same area which is necessary to provide for the relatively deep, knob-receiving pocket. As a result of the thinning down of the handle in the vicinity of the knob, the installed cover and crank handle assembly assumes a generally symmetrical overall configuration when the handle is folded down. The thinned down flap portion of the handle is slightly upturned away from the knob so as to avoid interference with the user's index finger and thumb when the knob is gripped and the handle is rotated to open or close the sash.

The pocket is provided with internal projections that serve as detents for the knob when the handle is folded down. As the knob is pushed into the recess, it engages the projections, and the interior wall of the pocket yields slightly so that a positive, secure snap action fit is sensed by the user. At the other extreme, interengaging surfaces between the mounting end of the handle and the adapter mount on the drive shaft provide positive limits for unfolding of the crank handle and serve as an indication of when the handle has been unfolded to its optimum operating position. Finger depressions in the cover on opposite sides of the pocket facilitate gripping of the thinned down flat portion by the user when the handle is to be unfolded.

One alternative embodiment of the invention includes an operator designed for use with egress windows in which the upright pivot axis of the sash remains adjacent the side of the upright frame member of the window throughout opening and closing of the sash, as contrasted to the standard situation in which the pivot axis of the sash shifts inwardly along the sill toward the mid-portion thereof and away from the upright side of the window frame as the sash is opened and closed. The worm gear of the operator is disposed close beside the helical gear and projects upwardly away from the helical gear at an oblique angle toward the cover and crank handle assembly. A long link arm fixed to the helical gear and rotatable therewith generally in the same plane as the helical gear transfers the rotary motion of the helical gear to the sash for swinging the sash open and closed. When the sash is closed, the long link arm lies along and generally parallel to the sill while crossing over the worm gear, a clearance hump in the arm allowing the arm to rest in such crossover relationship to the worm gear without interengaging with the worm gear or the housing in which it is contained.

### BRIEF DESCRIPTION OF THE DRAWINGS

FIG. 1 is a fragmentary front perspective view of a casement window employing an operator assembly in accordance with the principles of the present invention, the crank handle thereof being shown in its fully folded down position and the sash being shown in its closed position;

FIG. 1a is a fragmentary enlargement of FIG. 1;

FIG. 2 is a fragmentary perspective view of the casement window and operator assembly of FIG. 1 but showing the sash fully opened and the crank handle unfolded into its operating position;

FIG. 2a is a fragmentary enlargement of FIG. 2;

FIG. 3 is a fragmentary top plan view of the casement window and operator assembly of FIG. 1 with the sash fully closed and the crank handle folded down;

FIG. 4 is a fragmentary top plan view of the casement window and operator assembly in the opened and unfolded condition of FIG. 2;

FIG. 5 is an enlarged, fragmentary cross-sectional view through the window with the sash fully opened and the crank handle unfolded, corresponding to the condition of things in FIG. 4 and taken substantially along line 5-5 of FIG. 4;

FIG. 6 is a cross-sectional view of the window and operator assembly taken substantially along line 6-6 of FIG. 4;

FIG. 7 is a perspective view of the operator used in the operator assembly of FIGS. 1-6, the swing linkage of the operator being illustrated in its closed position corresponding to the fully closed position of the sash;

FIG. 8 is a fragmentary top plan view of the operator of FIG. 7 mounted on the window sill and illustrating the swing linkage in its fully opened position corresponding to the sash open position, the phantom lines corresponding to the closed position of the swing linkage;

FIG. 9 is an enlarged, fragmentary detail view of the cover and drive shaft area of the operator assembly illustrating details of construction, with parts being shown in cross-section for clarity;

FIG. 10 is an enlarged top, front perspective view of the operator assembly with one link of the swing linkage removed for clarity and with the cover and crank handle assembly shown in cross-section to reveal details of construction;

FIG. 11 is a transverse cross-sectional view through the operator assembly taken substantially along line 11-11 of FIG. 10 and illustrating the manner in which the finger depressions on opposite side of the cover in the area of the knob-receiving pocket facilitate gripping and unsnapping of the handle from its folded down position;

FIG. 12 depicts an alternative embodiment especially suited for egress windows, the sash being illustrated fully closed and the single swing link arm of the operator being in its closed position extending parallel to the sill;

FIG. 13 is a fragmentary top plan view similar to FIG. 12 but showing the sash fully opened and the crank handle unfolded;

FIG. 14 is an enlarged, fragmentary top plan view of the egress operator of FIGS. 12 and 13 showing the swing link arm in its closed position, the phantom lines illustrating the opened position of the link arm;

FIG. 15 is a fragmentary cross-sectional view of the egress operator taken substantially along line 15-15 of FIG. 14;

FIG. 16 is a transverse cross-sectional view of the egress operator taken substantially along line 16-16 of FIG. 15;

FIG. 17 is an exploded front perspective view of the preferred embodiment of the crank handle assembly and cover of the present invention;

FIG. 18 is a front perspective view thereof with the handle in its folded down position;

FIG. 19 is a top plan view of the folded down crank handle and cover;

FIG. 20 is a side elevational view of one side of the folded down crank handle and cover; and

FIG. 21 is an elevational view of the opposite side of the folded down crank handle and cover.

### DETAILED DESCRIPTION

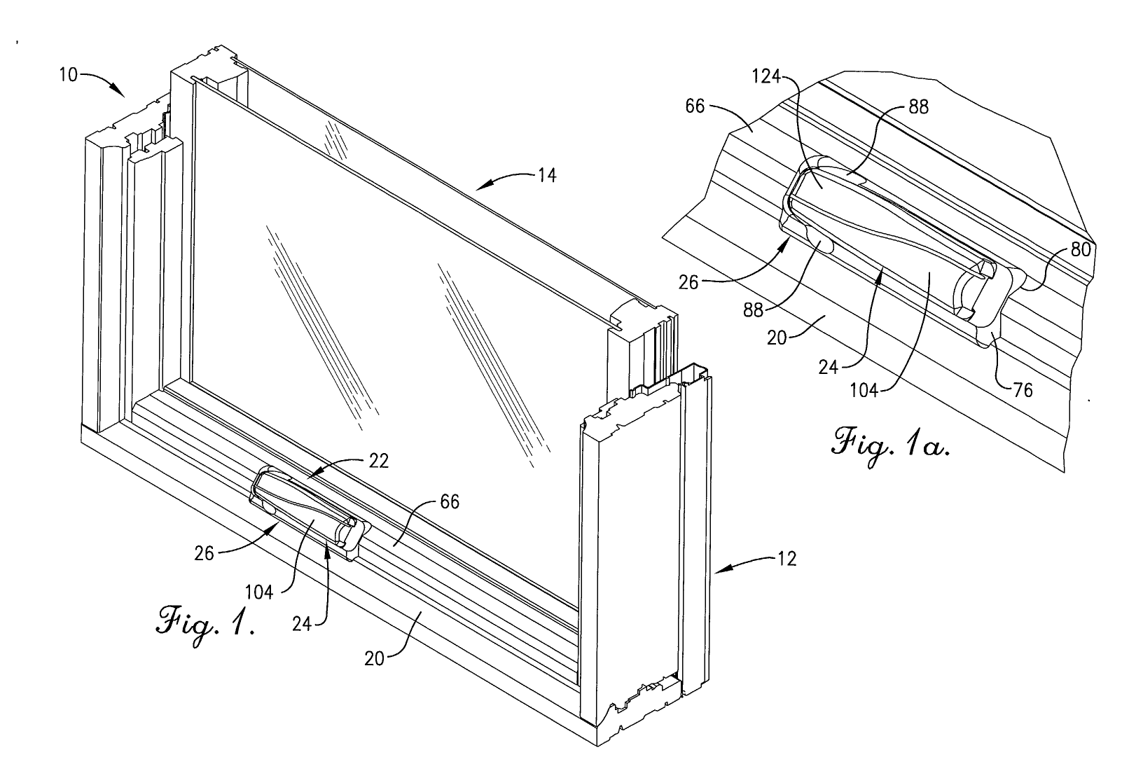

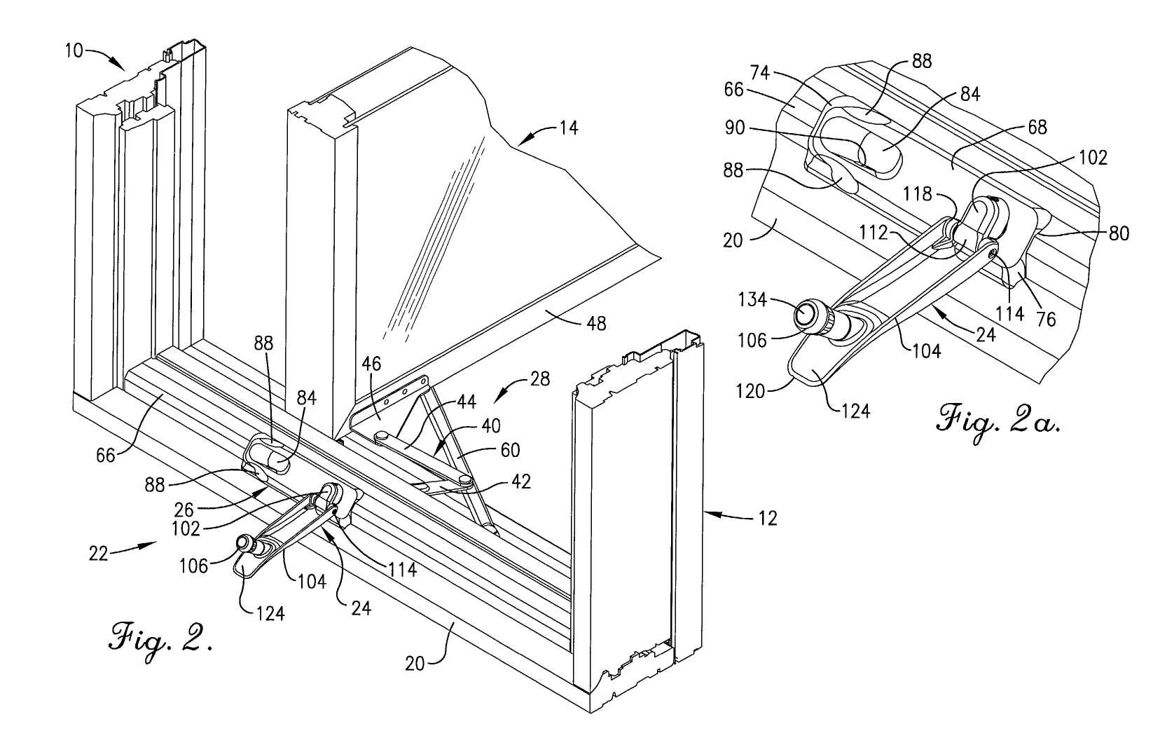

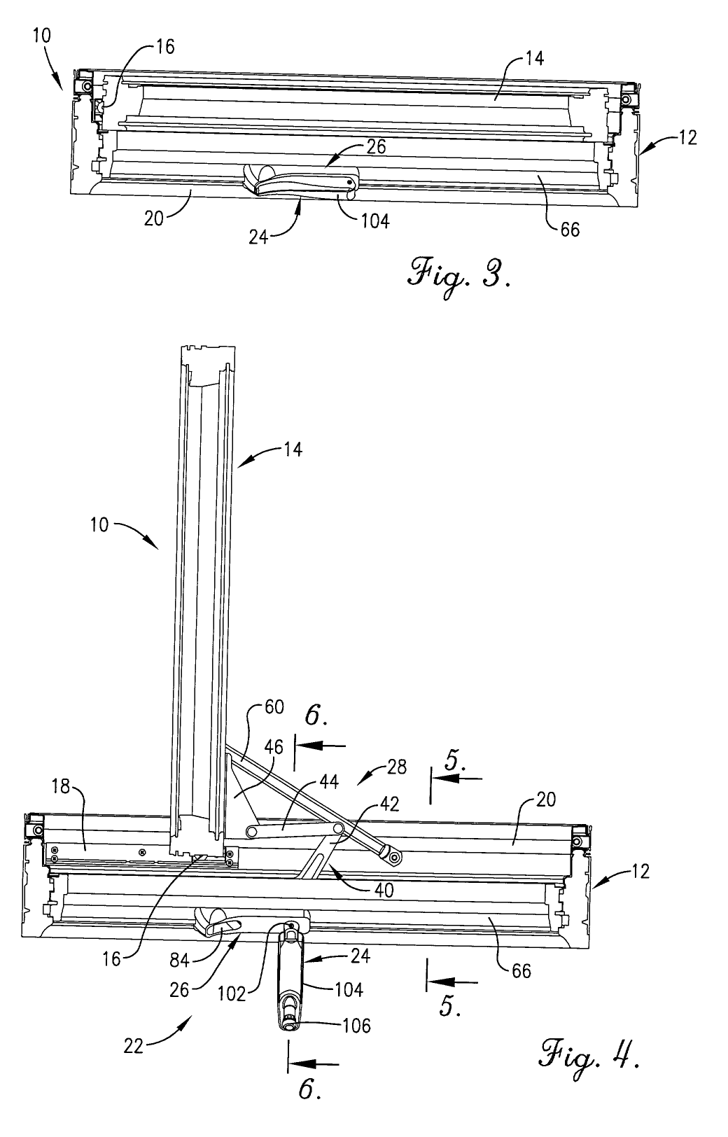

As well understood by those skilled in the art, the casement window 10 includes an open box-like, rectangular frame 12 and a sash 14 that is swingable between closed and opened positions illustrated in FIGS. 1 and 2 respectively (see also FIGS. 3 and 4). The sash 14 swings about an upright axis defined in part by a lower pivot 16 (FIG. 4) that is shifted left and right along a track 18 on sill 20 of window frame 12 as sash 14 is opened and closed. An operator assembly broadly denoted by the numeral 22 is operably coupled with sash 14 for effecting opening and closing thereof.

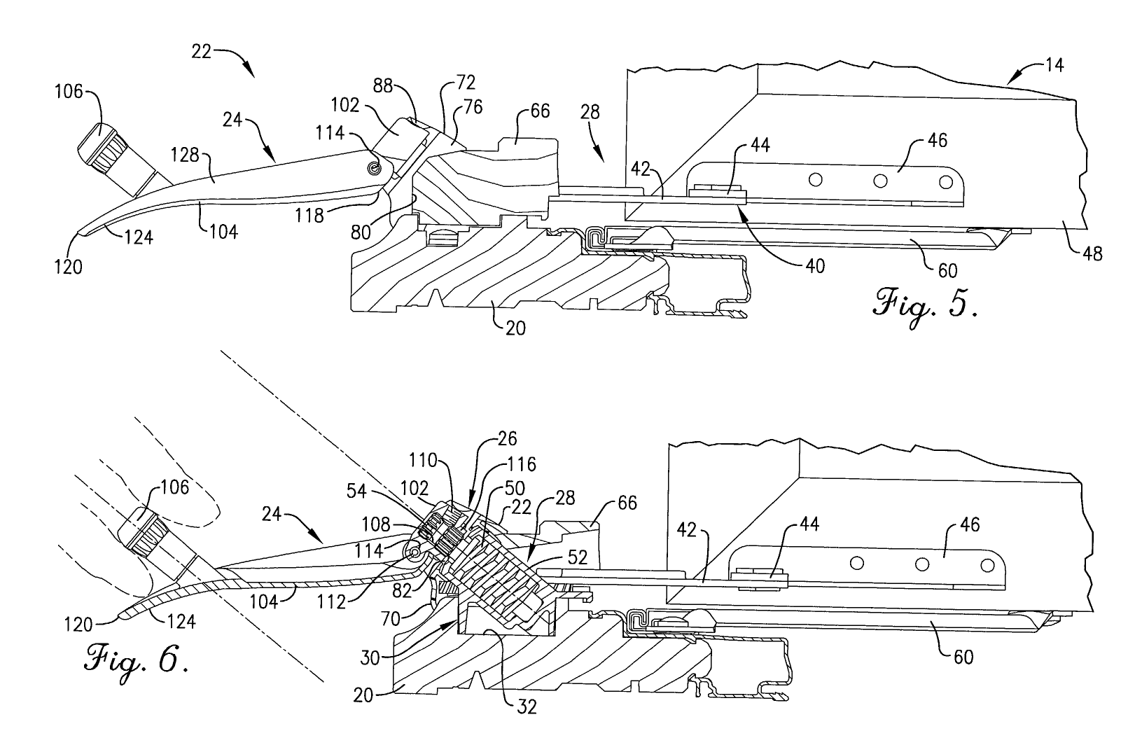

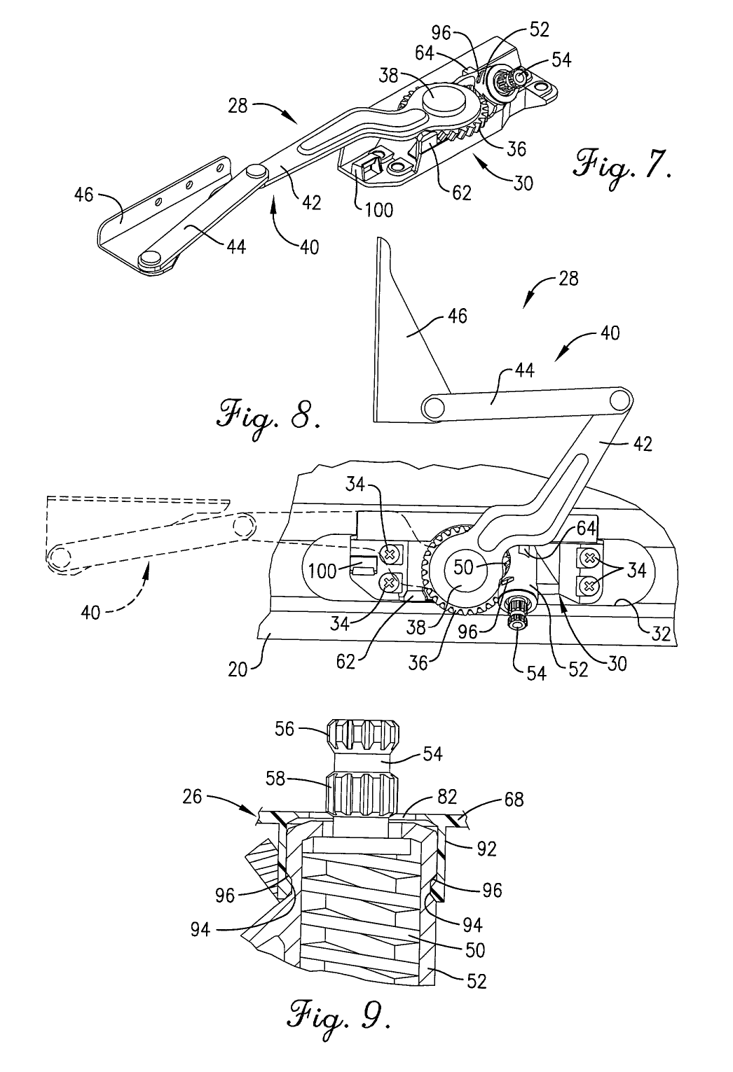

Operator assembly 22 broadly includes three major subassemblies, i.e., a crank handle assembly 24, a cover 26, and an operator 28 that translates the winding motion of the crank handle assembly 24 into pushing and pulling motion against the sash 14. Dealing first with the operator 28, such mechanism is illustrated in isolation in FIGS. 7 and 8 to facilitate an understanding of its construction. An elongated, cast metal base plate 30 of the operator comprises a support for other components of the operator and has its longitudinal axis extending parallel to the longitudinal axis of the sill 20 when plate 30 is installed in a recess 32 in sill 20 as illustrated in FIG. 8. Screws 34 (FIGS. 8, 10 and 11) securely fasten base plate 30 to sill 20. A flat bevel gear 36 is rotatably secured to base plate 30 by an upright stud 38. Swing linkage 40 includes an inner generally Z-shaped link arm 42 that is fixed at its inner end to the top surface of bevel gear 36 so that link arm 42 rotates with bevel gear 36 when gear 36 is operated. Linkage 40 further includes an outer link arm 44 pivotally secured to the outer end of inner arm 42, the outer arm 44 being pivotally connected at its outer end to a bracket 46 that is in turn secured to the inside face of the lower rail 48 of sash 14 as illustrated in FIGS. 2, 5 and 6.

Operator 28 further includes a worm gear 50 (see also FIGS. 6 and 9) contained within a generally cylindrical housing 52 integral with and forming a part of base plate 30. Housing 52 and worm gear 50 are disposed immediately beside helical gear 36 and project upwardly and outwardly at an oblique angle to the plane of the base plate 30 and to the plane of the sill 20. Housing 52 has a cutout (FIG. 8) in its sidewall that permits the worm gear 50 to engage and operably mesh with helical gear 36. An input drive shaft 54 rigidly affixed to worm gear 50 projects axially therefrom beyond housing 52 for the purpose of supplying input driving power to operator 28. Drive shaft 54 carries a pair of splined collars 56 and 58 for the purpose of drivingly connecting the crank handle assembly 24 with operator 28 as hereinafter explained. A strut 60 (FIGS. 2, 4, 5 and 6) is pivotally connected at an inner end to the sill 20 and at an outer in to the underside of sash rail 48 to assist swing linkage 40 in causing the sash to swing and the pivot point for sash 14 to shift along sill 20 during the opening and closing action. Inner link arm 42 engages an upstanding abutment 62 adjacent the front of base plate 30 when arm 42 is in the home position parallel to the longitudinal axis of sill 20 to prevent over swinging of linkage 40. At the other extreme, inner link arm 42 engages a stop 64 on housing 52 to determine the fully opened position of linkage 40.

As illustrated in FIGS. 1-6, a trim piece 66 forming a part of the window frame 12 overlies and is fastened to sill 20. Trim piece 66 is notched out in the region that would otherwise overlie and interfere with base plate 30 and the operating components thereon such that worm gear 50 projects upwardly and outwardly from sill 20 through trim piece 66 at approximately a 30° degree angle as illustrated in FIG. 6. Cover 26 overlies and conceals the notched out portion of trim piece 66 so that base plate 30 and its various operating components are likewise shielded from view. As illustrated in several of the figures, cover 26 sits on trim piece 66 on an incline relative to horizontal, essentially at right angles with the drive shaft 54 of operator 28.

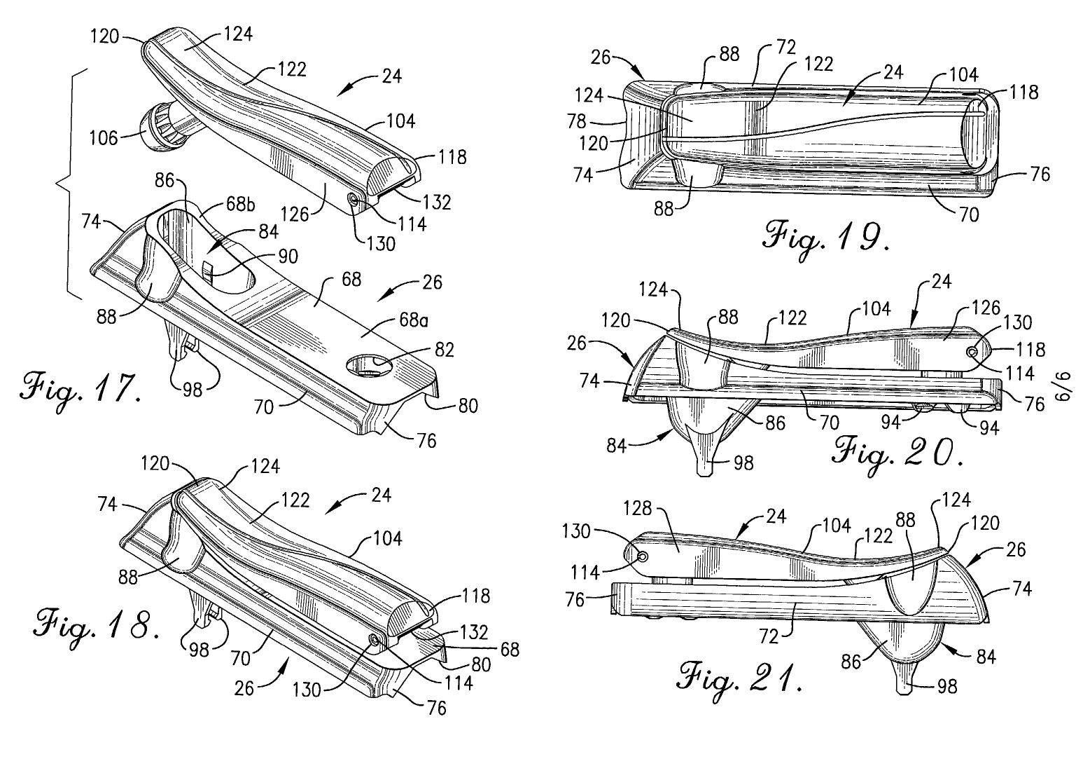

Preferably, cover 26 comprises a molded product constructed from synthetic resinous material. With reference to FIGS. 17-21, as well as other figures, it will be seen that cover 26 comprises a generally hollow, shell-like article having a concave underside and a flat top wall 68. Sidewalls 70 and 72 converge upwardly toward and intersect with top wall 68 so that top wall 68 spans sidewalls 70, 72. Cover 26 further includes a pair of opposite end walls 74 and 76 that converge upwardly and inwardly to the top wall 68. End walls 74 and 76 have notches 78 and 80 therein configured to matingly engage the beveled front edge of the trim piece 66 as illustrated particularly in FIGS. 1a, 2a and 5.

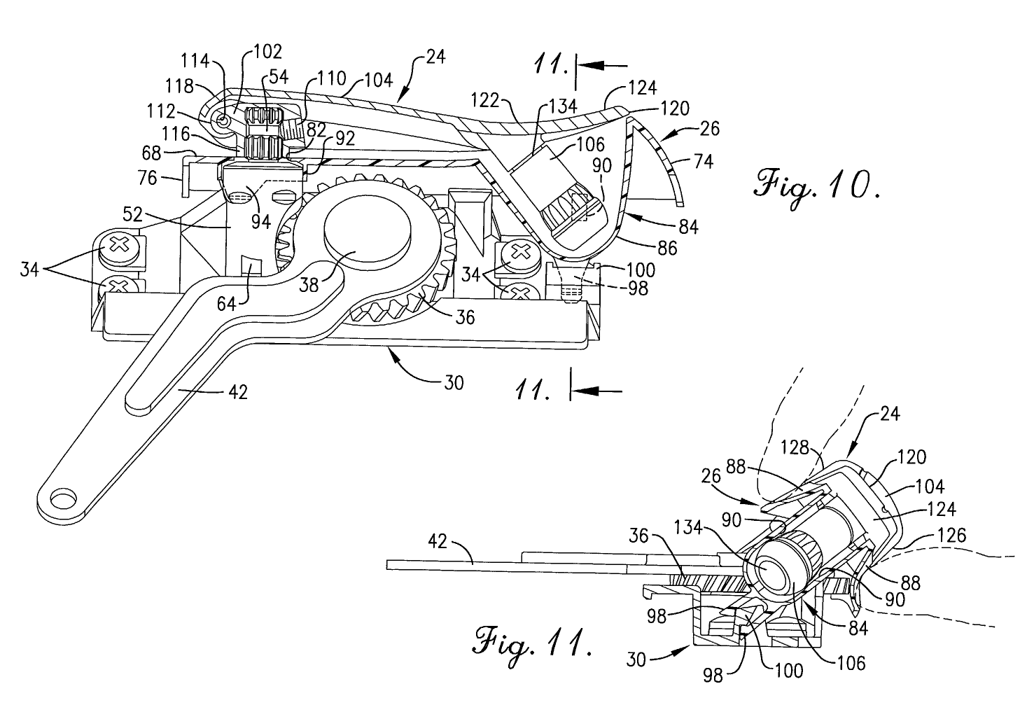

At the mounting end of cover 26, in a straight portion 68a thereof, top wall 68 has a hole 82 (FIGS. 9 and 17) through which the drive shaft 58 extends when cover 26 is in place on trim piece 66. The other end of top wall 68 curves gently upwardly and outwardly to present an upslope portion 68b leading from the straight portion 68a. An internal pocket 84 is located in the upslope portion 68b and includes an interior wall 86 that depends from the upslope portion 68b and projects downwardly below the lower extremity of sidewalls 70, 72 and end walls 74, 76. Sidewalls 70, 72 gradually increase in height as the wall 74 is approached so as to maintain a straight lower edge and yet intersect along the upper edge with top wall 68. Similarly, end wall 74 adjacent pocket 84 is substantially taller than end wall 76 adjacent the hole 82. A pair of generally vertically oriented finger depressions 88 are provided in the opposite sidewalls 70, 72 on opposite sides of pocket 84, and a pair of opposed projections 90 on interior pocket wall 86 (FIGS. 10, 11 and 17) serve as yieldable detents for snap-action retention of the knob of handle assembly 24 as will hereinafter be explained. It will be noted that interior wall 86 is slightly resiliently yieldable laterally inwardly and outwardly to provide the desired detent effect.

On the underside of cover 26, a depending collar 92 (FIG. 9) coaxial with hole 82 circumscribes the upper end of worm gear housing 52 and has a pair of opposed lugs 94 that snap into mating notches 96 on the housing 52 to yieldably retain cover 26 in place on the trim piece 66. Additionally, a pair of depending, opposed lugs 98 on the exterior of pocket wall 86 yieldably hook over an upstanding tab 100 on base plate 30 to provide additional snap action retention of cover 26 when the cover is pressed into position on trim piece 66 in overlying relationship to the base plate 30.

The crank handle assembly 24 includes two major components, i.e., an adapter mount 102 that serves to operably connect the handle assembly to drive shaft 54, and a crank handle 104 itself that is pivotally attached to mount 102 for swinging motion between the folded position of FIGS. 1 and 1a and the unfolded position of FIGS. 2 and 2a. Handle 104 includes an operating knob 106 projecting from the underside thereof which can be gripped by the operator once handle 104 is unfolded so as to provide a means of winding the handle 104 about the axis of drive shaft 54 and thereby operating operator 28 to open and close sash 14.

Dealing first with mount 102, it will be seen that mount 102 is shaped somewhat in the nature of a button or cap and has an internally splined bore 108 (FIG. 6) that matingly receives the splined collars 56, 58 of drive shaft 54, thereby drivingly coupling mount 102 with drive shaft 54. A set screw 110 in the side of mount 102 may be tightened down until its innermost tip end rests in the annular valley between collars 56 and 58 so as to preclude axial movement of mount 102 relative to drive shaft 54. A laterally outwardly projecting nose 112 on the opposite side of the mount 102 has a transverse bore that receives a roll pin 114 which projects outwardly beyond opposite side terminations of the nose 112. Roll pin 114 thus serves as a pivot pin for handle 104 about which the handle can swing between its folded and unfolded positions. Mount 102 has an integral, annular boss 116 depending from the underside thereof and circumscribing the bore 108. Boss 116 is of reduced size relative to the remainder of mount 102 and is somewhat smaller in diameter than hole 82 in cover 26 so that, depending upon manufacturing tolerances, boss 116 may fit down into hole 82 and thus reduce the distance by which the handle assembly 24 and cover 26 project out from window frame 12, i.e., reduce their effective profile. Mount 102 is preferably constructed from cast metal.

Crank handle 104 comprises an elongated body preferably formed of cast metal. It has a mounting end broadly denoted by the numeral 118, and an operating end broadly denoted by the numeral 120. The top surface of handle 104 is gently transversely arched from the mounting end 118 to a point generally adjacent knob 106 and is also gently arched in a longitudinal sense between the same points. The top surface is slightly reversely curved to present a gentle dip 122 opposite to the knob 106, from where the body continues upwardly and outwardly in the form of a flap extension 124 that is slightly upwardly curled. It will be seen that the handle 104 tapers in thickness from mounting end 118 toward operating end 120, the handle being preferably concave on its underside between mounting end 118 and knob 106 so as to present a pair of opposite sidewalls 126 and 128 that generally taper in height as operating end 120 is approached. Thus, overall, handle 104 is thinner in the vicinity of extension flap 124 than in the vicinity of mounting end 118. A pair of transverse, aligned holes 130 in sidewalls 126 and 128 adjacent mounting end 118 receive opposite ends of the roll pin 114 to pivotally attach handle 104 to mount 102. A transverse notched edge surface 132 at mounting end 118 of handle 104 is positioned to abuttingly engage the surface of boss 116 on mount 102 when handle 104 is fully unfolded as shown in FIG. 6 so as to prevent further unfolding of the handle.

The knob 106 is freely rotatable about a spindle 134 that projects from the underside of handle 104 at an oblique angle relative to the main portion of the body of handle 104 between mounting end 118 and the dip 122. The oblique attitude of spindle 134 thus correspondingly causes knob 106 to project obliquely from the underside of handle 104 in the same manner. The upturned nature of flap 124, being up and away from the obliquely projecting knob 106, provides more clearance for the user to grip knob 106 and manipulate handle 104 than would otherwise be the case, all as shown best in FIG. 6 and 10. Pocket 84 is sized and configured to fully receive knob 106 as handle 104 is swung to its folded down position, and it will be noted that flap 124 fully covers and conceals the otherwise visible open area of pocket 84 when handle 104 is folded down. It will be noted also that the gentle upward curvature of flap 124 generally matches the gentle curving upslope of the upslope portion 68b of cover 26 so that handle 104 blends in smoothly with cover 26 along the full length thereof when handle 104 is folded down. It is to be noted also from FIG. 19 that handle 104 is maintained fully within the outline of cover 26 when viewed in plan, thus contributing to a smooth, uncluttered design and providing a lack of protruding structures. Generally speaking, the contours and lines of handle 104 blend in smoothly with those of the cover 26 so that a sleek, smooth overall visual effect is obtained.

### Operation

Use of the operator assembly 22 should be apparent from the foregoing description. When the crank handle 104 is folded down against the cover 26 as shown in FIGS. 1, 1a and 18-21, handle 104 and cover 26 became a smooth, low-profile device with clean, graceful lines. The handle 104 and cover 26 tend to blend together as if comprising a single structure, and the fact that handle 104 serves a functional purpose as a means for mechanically operating sash 14 is not immediately apparent to the casual observer. Knob 106 is fully concealed by flap 124 within the deep pocket 84 and is also safely tucked away in a protected position where it cannot catch on window treatments or persons in the immediate vicinity.

Furthermore, it will be appreciated that handle 104 can be folded down and retained by the pocket 84 when sash 14 is in any position, not just when fully closed. Thus, when sash 14 is only part way open, for example, handle 104 can be folded down with knob 106 inserted into pocket 84 to gain the benefits of a compact operating unit even at those times. Moreover, sash 14 cannot move out of its selected partially opened position when knob 106 is received within pocket 84.

To open or close sash 14, the user merely places their thumb and index finger within depressions 88 as illustrated in FIG. 11 so as to grip opposite sides of the flap 124 of handle 104. A light tug on handle 104 will then unsnap knob 106 from detent projections 90 within pocket 84, allowing the handle 104 to be swung about pin 114 until edge surface 132 at the mounting end 118 of handle 104 engages boss 116 on mount 102. Handle 104 will then be at its fully unfolded position as illustrated in FIGS. 2, 2a and 4-6 wherein the axis of rotation of knob 106 is essentially parallel to the axis of rotation of drive shaft 54 as illustrated in FIG. 6. By gripping knob 106 between the thumb and index finger as illustrated in FIG. 6, handle 104 may then be wound about the axis of drive shaft 54, which causes operator 28 to swing and shift sash 14 to its opened position. Once sash 14 is opened or closed to the extent desired, handle 104 may be easily snapped back down into its folded position to once again conceal knob 106 and present the desired unobtrusive, compacted, low-profile configuration. It will be appreciated that during the winding action of handle 104, the flap 124 does not interfere with the user's thumb and index fingers due to the fact that flap 124 curls gently outwardly and upwardly away from knob 106 as illustrated in FIG. 6. Yet, flap 124 is fully capable of achieving its purpose of concealing knob 106 and pocket 84 when handle 104 is folded down.

### Alternative Embodiment

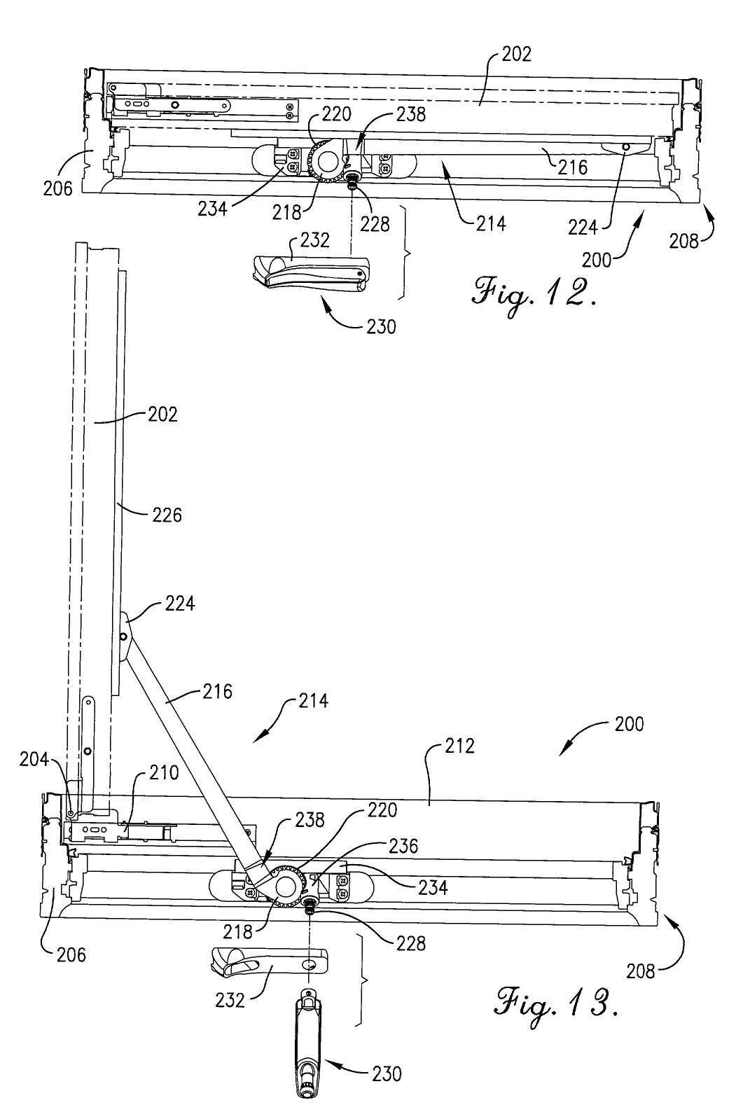

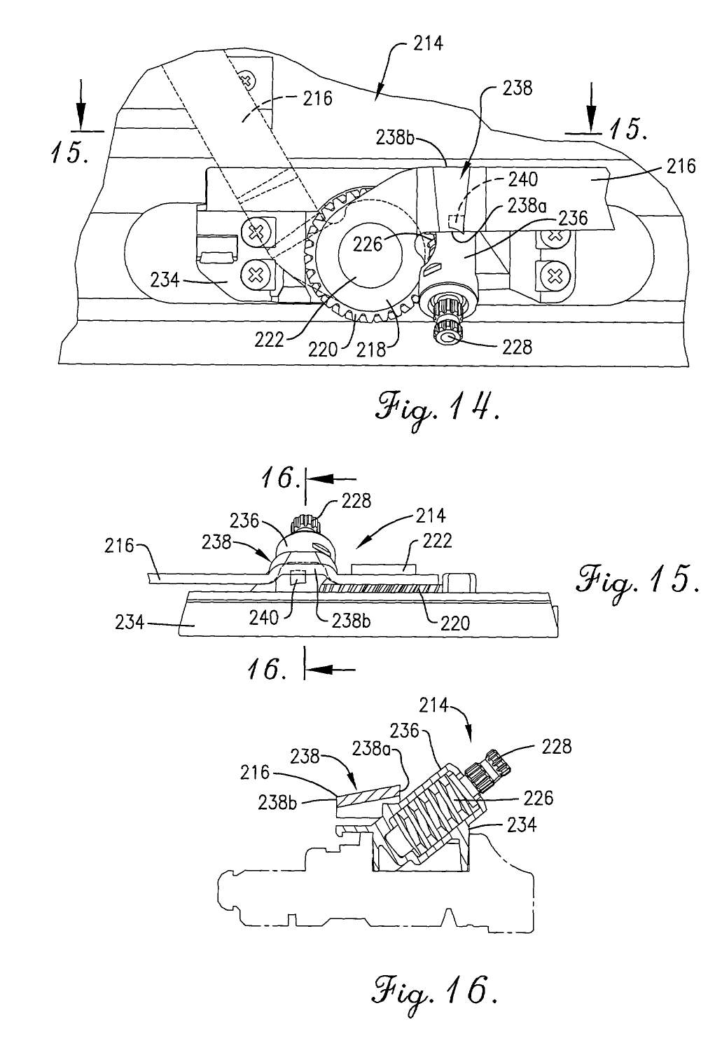

FIGS. 12-16 are directed to an alternative embodiment having particular utility for use with windows commonly referred to as “egress windows.” In an egress window, the sash swings about a vertical pivot that does not shift along the sill as the sash opens, but instead remains at one end of the sill adjacent the upright member of the window frame.

Such an arrangement is illustrated in FIGS. 12 and 13 wherein it may be seen that the egress casement window 200 has a sash 202 that swings about an upright pivot 204 located adjacent one of the upright frame members 206 of window frame 208. As well understood by those skilled in the arts, mechanism 210 on the sill 212 of window frame 208 permits the user to selectively shift sash 202 along sill 212 and toward the center of window frame 208 for cleaning purposes when the operator has been disconnected from sash 202.

The operator assembly 214 used in connection with egress window 200 is identical in all respects to operator assembly 22, except in the area of the swing linkage that pushes and pulls sash 202 between its various positions. Thus, the egress operator assembly 214 will only be briefly described, with the understanding that most of its components and mode of operation are identical to those in operator assembly 22.

Suffice it to point out, therefore, that in lieu of swing linkage 40 associated with operator assembly 22, egress operator assembly 214 uses swing linkage having a single long swing arm 216. At its inner end, arm 216 has a laterally offset, generally circular flange 218 that is fixed to the top surface of helical gear 220 for rotation with gear 220 about the axis of mounting stud 222. The offset relationship of flange 218 with respect to the remainder of arm 216 causes arm 216 to be disposed in an eccentric relationship to the axis of rotation of helical gear 220. At its opposite end, arm 216 is pivotally attached to a slide shoe 244 captured within a horizontal track 226 on the face of the lower, horizontally extending rail of sash 202. Thus, as helical gear 220 is rotated by worm gear 226 through drive shaft 228 by crank handle assembly 230 on the outside of cover 232, arm 216 swings about the axis of helical gear 220 and shoe 24 slides along track 226 to swing sash 202 between the closed position of FIG. 12 and the fully opened position of FIG. 13.

It will be seen that when sash 202 is in its closed position, link arm 216 overlies and extends along sill 212 generally parallel to the longitudinal axis of sill 212, and generally parallel to the longitudinal axis of base plate 234 of operator assembly 214. In this position, arm 216 crosses over housing 236 of worm gear 226, notwithstanding the fact that arm 216 lies essentially in the same plane as helical gear 220 and the lower end of worm gear housing 236. Such cross over relationship is afforded by virtue of a transversely extending clearance hump 238 in arm 216 generally adjacent flange 218, the hump 238 having a sufficient height to loop over and avoid engagement with stop 240 on worm gear housing 236 corresponding to the stop 64 of the first embodiment. Instead of engaging stop 240, the inboard edge 238a of hump 238 engages housing 236 at a point further outwardly along housing 236 to define the closed or fully folded position of arm 216. It will be noted that hump 238 is slightly inclined across the width of arm 216 in a manner to cause inboard edge 238a to be slightly higher than outboard edge 238b. Preferably arm 216 is constructed from flat plate metal material.

The preferred forms of the invention described above are to be used as illustration only, and should not be utilized in a limiting sense in interpreting the scope of the present invention. Obvious modifications to the exemplary embodiments, as herein above set forth, could be readily made by those skilled in the art without departing from the spirit of the present invention.

The inventor(s) hereby states their intent to rely on the Doctrine of Equivalents to determine and assess the reasonably fair scope of the present invention as pertains to any apparatus not materially departing from but outside the literal scope of the invention as set forth in the following claims.

1. An operating assembly for a casement window comprising:
an operator including a drive shaft and linkage responsive to rotation of said drive shaft for swinging a sash of the window between open and closed positions;
a cover attached to said operator in covering relationship therewith and having a hole;
a mount outside of the cover and operably coupled with said drive shaft through said hole; and
a crank handle pivotally coupled with said mount for swinging movement relative thereto between a compact, folded position covering said mount in overlying relationship to the cover and an extended, unfolded position uncovering the mount and projecting outwardly from the cover to dispose the crank handle for rotation around the axis of said drive shaft to operate said linkage,
said crank handle having a top side and an underside,
said crank handle including a knob rotatably secured to said underside and projecting laterally outwardly therefrom to permit manual gripping of the knob and winding of the crank handle about said axis of the drive shaft when the crank handle is unfolded,
said cover having a pocket for receiving the knob when the crank handle is in said folded position.

2. An operating assembly as claimed in claim 1,
said cover having a pair of sidewalls and a top wall spanning said sidewalls that faces the underside of the crank handle when the crank handle is in its folded position,
said pocket being in said top wall,
said sidewalls having a pair of opposed depressions therein on opposite sides of the pocket to facilitate gripping of the crank handle for unfolding.

3. An operating assembly as claimed in claim 2,
said pocket including an interior wall having a detent operable to engage and yieldably retain the knob when the crank handle is in its folded position.

4. An operating assembly as claimed in claim 3,
said detent comprising at least one projection on said interior wall disposed to engage the knob when the crank handle is slightly outboard of its folded position,
said interior wall being capable of flexing resiliently when the knob engages the projection whereby to permit the knob to yieldably pass by the projection under the application of sufficient folding or unfolding force to the crank handle.

5. An operating assembly as claimed in claim 1,
said cover having a pair of sidewalls and a top wall spanning said sidewalls that faces the underside of the crank handle when the crank handle is in its folded position,
said pocket being in said top wall,
said pocket including an interior wall having a detent operable to engage and yieldably retain the knob when the crank handle is in its folded position.

6. An operating assembly as claimed in claim 1,
said crank handle having a mounting end coupled with the mount and an operating end supporting said knob,
said crank handle having an integral flap at said operating end extending beyond the knob for covering the pocket and concealing the knob when the knob is received in the pocket.

7. An operating assembly as claimed in claim 6,
said knob projecting generally obliquely out of the plane of the crank handle and away from said mounting end thereof,
said flap being outturned with respect to the knob to provide additional clearance for gripping the knob and operating the crank handle.

8. An operating assembly as claimed in claim 7,
said crank handle comprising an elongated body having a length, a width, and a thickness,
said body tapering in thickness and curving outwardly as said operating end of the crank handle is approached to render said flap outwardly curved and thinner than said mounting end of the crank handle.

9. An operating assembly as claimed in claim 8,
said body having a concavity adjacent said mounting end thereof on the underside of the crank handle for receiving the mount when the crank handle is in its folded position.

10. An operating assembly as claimed in claim 8,
said cover having a pair of sidewalls and a top wall spanning said sidewalls that faces the underside of the crank handle when the crank handle is in its defolded position,
said pocket being in said top wall,
said sidewalls having a pair of opposed depressions therein on opposite sides of the pocket to facilitate gripping of the crank handle in the area of the flap for unfolding.

11. An operating assembly as claimed in claim 1,
said cover presenting a certain outline as viewed in top plan,
said crank handle being disposed within said outline when the crank handle is in its folded position.

12. An operating assembly as claimed in claim 1,
said mount and said crank handle having interengageable stop surfaces disposed to prevent unfolding of said crank handle beyond said unfolded position.

13. An operating assembly as claimed in claim 1,
said mount including an enlarged head and a reduced diameter boss integral with said head,
said boss having a smaller diameter than said hole in the cover,
said mount including a bore extending through said boss and into the head for receiving said drive shaft.

14. An operating assembly as claimed in claim 1,
said operator further including a base plate having a longitudinal axis, a helical gear mounted on said plate for rotation about a generally upright axis, and a worm gear supported by said plate in meshing engagement with said helical gear and extending generally upwardly therefrom at an oblique angle thereto for rotation with the drive shaft about the axis of said drive shaft,
said linkage including an arm fixed to said helical gear for rotation therewith between a closed sash position in which the arm lies generally parallel to the longitudinal axis of the plate and crosses over the worm gear, and an open sash position in which the arm is swung out at an angle to said longitudinal axis,
said arm having a transverse clearance hump therein for clearing the worm gear when the arm crosses over the worm gear in the closed sash position.

15. An operating assembly as claimed in claim 14,
said arm being constructed from flat plate material,
said hump being slightly inclined across the width of the arm so as to present a high side facing the worm gear when the arm is in its closed sash position and a low side facing away from the worm gear when the arm is in its closed sash position.

16. A cover for use with the folding crank handle and operator of a casement window operating assembly wherein the crank handle has a knob and the operator has a drive shaft, said cover comprising:
a pair of elongated, laterally spaced apart sidewalls;
an elongated top wall spanning said sidewalls and integrally connected thereto;
a hole at one end of the top wall for receiving the drive shaft of the operator when the cover is installed; and
a pocket at the other end of the top wall for receiving the knob of the handle when the handle is folded.

17. A cover as claimed in claim 16,
said sidewalls having a pair of opposed depressions therein on opposite sides of the pocket.

18. A cover as claimed in claim 17,
said pocket including an interior wall having at least one projection thereon,
said interior wall being capable of slight resilient flexing to allow said projection to function as a detent when the knob of the handle is received in the pocket.

19. A cover as claimed in claim 18,
said top wall including a generally straight portion and a generally upwardly curved upslope portion,
said hole being in said straight portion and said pocket being in said upslope portion.

20. A cover as claimed in claim 19,
said cover being constructed from a synthetic resinous material.

21. A cover as claimed in claim 16,
said pocket including an interior wall having at least one projection thereon,
said interior wall being capable of slight resilient flexing to allow said projection to function as a detent when the knob of the handle is received in the pocket.

22. A cover as claimed in claim 16,
said top wall including a generally straight portion and a generally upwardly curved upslope portion,
said hole being in said straight portion and said pocket being in said upslope portion.

23. A cover as claimed in claim 16,
said cover being constructed from a synthetic resinous material.

24. A folding crank handle assembly for the drive shaft of a casement window operator, said assembly comprising:
a mount adapted to be operably attached to said drive shaft for rotation with the drive shaft about an axis of rotation; and
a crank handle pivotally coupled with said mount for swinging movement relative thereto between a folded, storage position covering said mount and an unfolded, operating position projecting laterally outwardly from said axis of rotation,
said crank handle having a top side and an underside,
said crank handle including a knob rotatably secured to said underside and projecting laterally outwardly therefrom,
said crank handle having a mounting end coupled with the mount and an operating end supporting said knob,
said crank handle having an integral flap at said operating end extending beyond the knob.

25. A folding crank handle assembly as claimed in claim 24,
said knob projecting generally obliquely out of the plane of the crank handle and away from said mounting end thereof,
said flap being outturned with respect to the knob to provide additional clearance for gripping the knob and operating the crank handle.

26. A folding crank handle assembly as claimed in claim 25,
said crank handle comprising an elongated body having a length, a width, and a thickness,
said body tapering in thickness and curving outwardly as said operating end of the crank handle is approached to render said flap outwardly curved and thinner than said mounting end of the crank handle.

27. A folding crank handle assembly as claimed in claim 26,
said body having a concavity adjacent said mounting end thereof on the underside of the crank handle for receiving the mount when the crank handle is in its folded position.

28. A folding crank handle assembly as claimed in claim 27,
said crank handle being constructed from metal.

29. A folding crank handle assembly as claimed in claim 24,
said crank handle comprising an elongated body having a length, a width, and a thickness,
said body tapering in thickness and curving outwardly as said operating end of the crank handle is approached to render said flap outwardly curved and thinner than said mounting end of the crank handle.

30. A folding crank handle assembly and cover combination for the operator of a casement window comprising:
a cover having a hole for accessing a drive shaft of the operator; and
a folding crank handle assembly comprising
a mount adapted to be operably attached to the drive shaft through said hole in the cover for rotation with the drive shaft about an axis of rotation, and
a crank handle pivotally coupled with said mount for swinging movement relative thereto between a compact, folded position covering said mount in overlying relationship to the cover and an extended, unfolded position uncovering the mount and projecting outwardly from the cover to dispose the crank handle for rotation around the axis of said drive shaft to operate the operator,
said crank handle having a top side and an underside,
said crank handle including a knob rotatably secured to said underside and projecting laterally outwardly therefrom to permit manual gripping of the knob and winding of the crank handle about said axis of the drive shaft when the crank handle is unfolded,
said cover having a pocket for receiving the knob when the crank handle is in said folded position.

31. The combination as claimed in claim 30,
said cover having a pair of sidewalls and a top wall spanning said sidewalls that faces the underside of the crank handle when the crank handle is in its folded position,
said pocket being in said top wall,
said sidewalls having a pair of opposed depressions therein on opposite sides of the pocket to facilitate gripping of the crank handle for unfolding.

32. The combination as claimed in claim 31,
said pocket including an interior wall having a detent operable to engage and yieldably retain the knob when the crank handle is in its folded position.

33. The combination as claimed in claim 32,
said detent comprising at least one projection on said interior wall disposed to engage the knob when the crank handle is slightly outboard of its folded position,
said interior wall being capable of flexing resiliently when the knob engages the projection whereby to permit the knob to yieldably pass by the projection under the application of sufficient folding or unfolding force to the crank handle.

34. The combination as claimed in claim 30,
said cover having a pair of sidewalls and a top wall spanning said sidewalls that faces the underside of the crank handle when the crank handle is in its folded position,
said pocket being in said top wall,
said pocket including an interior wall having a detent operable to engage and yieldably retain the knob when the crank handle is in its folded position.

35. The combination as claimed in claim 30,
said crank handle having a mounting end coupled with the mount and an operating end supporting said knob,
said crank handle having an integral flap at said operating end extending beyond the knob for covering the pocket and concealing the knob when the knob is received in the pocket.

36. The combination as claimed in claim 35,
said knob projecting generally obliquely out of the plane of the crank handle and away from said mounting end thereof,
said flap being outturned with respect to the knob to provide additional clearance for gripping the knob and operating the crank handle.

37. The combination as claimed in claim 36,
said crank handle comprising an elongated body having a length, a width, and a thickness,
said body tapering in thickness and curving outwardly as said operating end of the crank handle is approached to render said flap outwardly curved and thinner than said mounting end of the crank handle.

38. The combination as claimed in claim 37,
said body having a concavity adjacent said mounting end thereof on the underside of the crank handle for receiving the mount when the crank handle is in its folded position.

39. The combination as claimed in claim 37,
said cover having a pair of sidewalls and a top wall spanning said sidewalls that faces the underside of the crank handle when the crank handle is in its folded position,
to said pocket being in said top wall,
said sidewalls having a pair of opposed depressions therein on opposite sides of the pocket to facilitate gripping of the crank handle in the area of the flap for unfolding.

40. The combination as claimed in claim 30,
said cover presenting a certain outline as viewed in top plan,
said crank handle being disposed within said outline when the crank handle is in its folded position.

41. The combination as claimed in claim 30,
said mount and said crank handle having interengageable stop surfaces disposed to prevent unfolding of said crank handle beyond said unfolded position.

42. The combination as claimed in claim 30,
said mount including an enlarged head and a reduced diameter boss integral with said head,
said boss having a smaller diameter than said hole in the cover,
said mount including a bore extending through said boss and into the head for receiving said drive shaft.

43. The combination as claimed in claim 30,
said crank handle comprising an elongated body having a length, a width, and a thickness,
said body tapering in thickness and curving outwardly as said operating end of the crank handle is approached to render said flap outwardly curved and thinner than said mounting end of the crank handle.

44. An operator for the swingable sash of a casement window comprising:
a base plate having a longitudinal axis;
a helical gear mounted on said plate for rotation about a generally upright axis;
a worm gear supported by said plate in meshing engagement with said helical gear and extending generally upwardly therefrom at an oblique angle thereto;
a drive shaft fixed to and projecting axially from said worm gear for rotating the worm gear and the helical gear; and
an arm fixed to said helical gear for rotation therewith between a closed sash position in which the arm lies generally parallel to the longitudinal axis of the plate and crosses over the worm gear, and an open sash position in which the arm is swung out at an angle to said longitudinal axis,
said arm having a transverse clearance hump therein for clearing the worm gear when the arm crosses over the worm gear in the closed sash position.

45. An operator as claimed in claim 44,
said arm being constructed from flat plate material,
said hump being slightly inclined across the width of the arm so as to present a high side facing the worm gear when the arm is in its closed sash position and a low side facing away from the worm gear when the arm is in its closed sash position.
